(19) United States
(12) Patent Application Publication
(10) Pub. No.: US 2010/0099815 A1
(43) Pub. Date: Apr. 22, 2010

(54) COUPLED CHARGE TRANSFER NANOTUBE DOPANTS

(75) Inventors: Andrew G. Rinzler, Newberry, FL (US); John R. Reynolds, Gainesville, FL (US); Ryan M. Walczak, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: UNIVERSITY OF FLORIDA RESEARCH FOUNDATION, INC., GAINESVILLE, FL (US)

(21) Appl. No.: 12/527,847

(22) PCT Filed: Feb. 20, 2008
(86) PCT No.: PCT/US08/54372

§ 371 Date: Nov. 24, 2009

Related U.S. Application Data
(60) Provisional application No. 60/890,704, filed on Feb. 20, 2007.

(51) Int. Cl. C08K 3/04; C08F 120/10

(52) U.S. Cl. 524/560; 525/329.9; 977/742

(57) ABSTRACT

Stable charge-transfer doping of carbon nanotubes is achieved using a dopant containing polymer (DCP) wherein the DCP has a multiplicity of dopant moieties that are capable of donating electrons to or accepting electrons from the nanotubes linked to a polymer. The DCP has a sufficient number of dopant moieties connected to the polymer such that when charge transfer equilibrium between a particular dopant moiety and the nanotubes is in a dissociated, or dedoped state, the dopant moiety remains tethered by a linking moiety to the polymer and remains in the vicinity of the nanotubes as the polymer remains bound to the tube by at least one bound dopant of the DCP. The linking groups are selected to permit the presentation of the dopant moieties to the nanotubes in a manner that is unencumbered by the polymer backbone and can undergo charge transfer doping.

### CROSS-REFERENCE TO RELATED APPLICATION

The present application claims the benefit of U.S. application Ser. No. 60/890,704, filed Feb. 20, 2007, which is hereby incorporated by reference herein in its entirety, including any figures, tables, or drawings.

### FIELD OF THE INVENTION

The invention relates to charge transfer moieties that are multiply attached to a polymeric backbone and the doping of carbon nanotubes doped therewith.

### BACKGROUND

Single wall carbon nanotubes are widely under investigation for numerous applications that seek to exploit their electronic transport properties. Among the characteristics that imbue the nanotubes with great promise is the ability to modulate their electrical conductivity by chemical charge transfer doping. For semiconducting nanotubes, those of chiral index (n,m) for which n-m is not divisible by 3, doping with charge-transfer, electron donors results in an increased n-type carrier density in proportion to the doping concentration. This doping can increase the conductivity of the nanotubes by orders of magnitude above that of the undoped nanotubes. Likewise, doping with charge-transfer electron acceptors can greatly increase their conductivity yielding a p-type carrier density that is doping concentration dependent. In principle, this dependence of the carrier density on the doping concentration provides a finely tunable control of both the degree of conductivity and the carrier type for semiconducting nanotubes. Such chemical charge transfer doping has been exploited in both single nanotube and nanotube network based field effect transistors (FETs) to obtain n-type or p-type FETs and to modify the gate voltages at which they turn on. Importantly, both FET types are required for implementation of modern digital logic families.

Charge transfer doping also provides a measure of control over the conductivity of metallic nanotubes, which are those of chiral index n−m=0, mod 3. The carrier density for an undoped metallic nanotube, while non-zero, is relatively small. By sufficiently charge transfer doping the nanotube, its Fermi level shifts to underlie a van Hove singularity and its carrier density is substantially increased, thereby increasing its conductivity.

Thin nanotube films are presently being explored in a variety of applications requiring transparent electrical conductors, e.g.: for the charge injecting electrodes in light emitting diodes; for the charge collection electrodes in photovoltaic devices; and for the contact pads in flexible, transparent touch screens. Charge transfer doping controls the conductance of such films in two ways: by direct control over the carrier density of the individual nanotubes making up the films and by the modification of the Schottky barriers developed at tube-tube contacts that affect the electrical impedance across such tube-tube junctions within the films. Charge transfer based tunability of the Fermi level in nanotube films also provides a measure of control over the Fermi-level line-up between the film and a semiconductor, either inorganic or organic, without the Fermi level pinning that plagues numerous metal-semiconductor contacts. This permits rational adjustment of the contact barrier height to optimize the device function.

The single wall nanotubes (SWNTs) possess an atomic structure so similar to that of graphene that it was natural for researchers to look to the vast body of work on graphite charge transfer complexes, also called graphite intercalation complexes (GICs), to find suitable charge transfer dopants of the nanotubes. All the known dopants of graphite that have been examined, also dope the nanotubes.

Highly graphitized carbon fibers that are heavily charge transfer doped approach the electrical conductivity of metals. Motivated by the possibility of replacing metals by strong, light-weight carbon fibers, for example in power transmission lines, much effort has been expended to find the most stable dopants of graphite. Unfortunately, despite numerous literature claims of “stable” doping, all highly doped GICs lose an appreciable fraction of that doping with time. This is true not only for n-type dopants, i.e. donor dopants, where the GIC salt reacts with water vapor in the atmosphere, but also for air/water stable p-type dopants, i.e. acceptor dopants. The instability problem is worse for the nanotubes. The timescale for doping graphite is rather long. The dopants must intercalate in between graphene sheets, initially separated by 0.34 nm, and diffuse long distances in a 2-dimensional, confined space. The dopants that have already intercalated must move inwards to make room for further dopants entering at the edges. This confinement also greatly slows dedoping, where the dopants are lost by evaporate or other processes from the edges. For graphite, typical doping/dedoping timescales measure in days to weeks. In the case of the nanotubes, the timescales for doping and dedoping are both much faster. For individual nanotubes, the dopants reside on a surface from which they need not diffuse to escape. For nanotube bundles, diffusion from the interior to the exterior in the direction perpendicular to the bundle axis only requires diffusing across a distance that is, at most, half the bundle diameter, a distance on the order of ten nanometers. For nanotube films and networks, which are typically disordered, the empty space between nanotube bundles, through which the dopants can escape, has open volumes with characteristic linear dimension measuring some tens of nanometers. These make diffusion, both into and out of nanotubes, a more rapid process that takes only minutes to hours.

While charge transfer doping of carbon nanotubes is important for their numerous potential applications, the instability of charge transfer doping via the spontaneous de-doping of the nanotubes with time precludes the commercial realization of many applications. The necessary conditions to realize most electronic or electro-optic applications are: controlling the degree of doping, i.e. the specific number of electrons transferred to or from the nanotubes per unit of nanotube length, to within some acceptable tolerance necessary for the device function; and stability of the specific degree of doping over time, i.e. the specific number of transferred electrons per unit of nanotube length must remain constant, within some acceptable tolerance, for the lifetime of the device.

Hence, the goal of a doped carbon nanotube composition where the degree of doping is designed controlled, and stable over time remains unfulfilled.

### SUMMARY OF THE INVENTION

The invention is directed to dopant coupled polymers (DCPs) and stable carbon nanotubes charge transfer complexes with these DCPs. A DCP is a polymer containing a multiplicity of dopant moieties capable of donating electrons to or accepting electrons from a carbon nanotube surface where a linking moiety connects the dopant moiety to the polymer. The polymer can be a homopolymer or a copolymer with an architecture that is linear, branched, hyperbranched, dendritic, or star shaped, and can be an architecture that can be converted into a network. The polymer backbone can be non-conjugated, partially conjugated or fully conjugated, as it can provide specific properties to a composite in addition to presenting the charge transfer dopants to the nanotubes in a manner that stable and controlled doping is possible.

The dopant moieties can be electron accepting units such as those derived from TCNQs, halogenated-TCNQs, 1,1-dicyanovinylenes, 1,1,2-tricyanovinylenes, benzoquinones, pentafluorophenol, dicyanofluorenone, cyano-fluoroalkylsulfonyl-fluorenones, pyridines, pyrazines, triazines, tetrazines, pyridopyrazines, benzothiadiazoles, heterocyclic thiadiazoles, porphyrins, phthalocyanines, or electron accepting organometallic complexes. The dopant moieties can be electron donating units such as those derived from tetrathiafulvalene (TTF), bis-ethylenedithiolo-TTF (BEDT-TTF), amines, polyamines, tetraselenafulvalenes, fused heterocycles, heterocyclic oligomers, and electron donating organometallic complexes.

The multiplicity of dopant moieties has a sufficient number of dopant moieties such that the probability of all dopant moieties on a DCP being simultaneously in an uncomplexed state is sufficiently small that such a state effectively does not occur. The number of dopant moieties per polymer chain can vary depending on the strength of the charge transfer complex, and other factors, but in general when at least five dopant moieties are linked to a polymer, sufficient stability occurs. The number of dopant moieties per polymer chain and their disposition along the polymer backbone can vary in a manner that the amount of charge transfer associations when mixed with carbon nanotubes is limited to less than a saturated state. In this manner the electrical properties of the nanotubes can be tuned via the selected structure of the DCP that are complexed to the nanotubes.

The linking moiety can be part of the polymer backbone, but generally will be one that connects the dopant moiety to the backbone to allow an optimal orientation of the dopant moiety to the carbon nanotubes. The linking moiety can be a non-conjugated chain where one atom, in the case of a highly flexible, conformationally free, polymer backbone is employed, to as many as 50 atoms or more, if needed to decouple the conformational freedom of the dopant moiety from the polymer backbone. Linking groups with four to about 20 atoms in a non-conjugated chain are generally sufficient to decouple the orientation of the dopant moiety from the polymer backbone when combined with nanotubes. In some cases it is possible that more rigid, less conformationally free, polymers and linking groups, such as conjugated polymers and linking groups, can be used. In these cases, the conformations assumed by these polymers and linking groups are complementary to the surface of a carbon nanotube such that multiple dopant moieties can readily be oriented relative to the nanotubes surface for promotion of charge transfer doping.

An embodiment of the invention is a method to dope carbon nanotubes where at least one polymer with a multiplicity of dopant moieties linked via a linking moiety to the polymer and at least one carbon nanotubes are provided and mixed. The polymer can be provided as a preformed polymer, as a monomer, or even as a polymer lacking the dopant moieties where the DCP is formed in the presence of the nanotubes. Additionally, the method can include a step of cross-linking such that a polymer network is formed around the carbon nanotubes, generally after an equilibrium dopant state is achieved before cross-linking. The DCP, or constituents to form the DCP around the nanotubes, can be provided as a liquid or in solution. The degree of doping can be less than saturated based on the structure of the polymer and the manner in which the DCP is mixed with the carbon nanotubes. The method can include the steps of providing a monomeric dopant that competitively complexes with the nanotubes such that saturation doping occurs, and a subsequent step of removing the monomeric dopant, which leaves substantially only the DCP as a dopant in a state that is less than saturated, and results in desired electronic properties of the nanotubes.

Another embodiment of the invention is the doped nanotube composition of at least one carbon nanotubes, at least one polymer containing a multiplicity of dopant moieties linked to the polymer via a linking moiety capable of donating or accepting electrons from a carbon nanotube surface. The ratio of the mass of nanotubes to the mass of polymer provides a specific conductivity to the composition that can be predetermined by the structure of the DCP and the mode of its combination with the nanotubes.

### DETAILED DESCRIPTION

Chemical binding energies are ordered: van der Waals<ionic<covalent and while debundling nanotubes against their supposedly “weak” van der Waals interaction with each other is known to be difficult, the comparatively “strong” ionic bonds of the charge transfer dopants are readily broken to dedope graphite and the nanotubes. This apparent anomaly arises because the relative binding energies, as ordered above, are specific binding energies, i.e. they are per isolated atom pair. The van der Waals binding of two nanotubes involves thousands of atom pair binding interactions while, in contrast, the ionic bond between a host and a charge transfer dopant involves the Coulombic attraction of a single fractional charge transferred between a single dopant molecule and the host. The aggregate interaction of the many van der Waals bonds greatly exceeds that of a lone ionic bond.

Moreover charge transfer reactions are generally described as involving only a fractional charge. A means for rationalizing fractional charge, in the face of charge being quantized in the fundamental unit e, is to consider the transferred electron as spending the corresponding fraction of its time, per unit of time, associated with the host (donor doping). The corollary to this is that the electron spends the remaining fraction of its time back-transferred to the dopant. During such back transfer there is in effect no ionic bond and the dopant is free to desorb. Thus, single moiety charge transfer doping and dedoping is an equilibrium process, whose lifetime is also dependent on the volatility of the dopant.

Hence, as van der Waals bonds, though weak, can act in concert to stabilize a strong interaction, the present invention is directed to a method to controllably dope nanotubes and dopant coupled polymers to form stable charge transfer complexes with nanotubes, where dopant moieties are coupled to each other by covalent bonds in the polymer. In this manner charge back-transfer that occurs between one doping moiety and the nanotube is not free to desorb from the nanotubes as it is held in place by other charge transfer bound moieties of the dopant coupled polymer during the lifetime of the charge back-transfer to a dopant moiety. If the back-transfer lifetime is expressed as (1−t), where t is the fractional charge transferred, the probability of desorption for a single dopant can be expressed as P=A(1−t), where A is a coefficient accounting for other characteristic factors, such as van der Waals interactions and thermal fluctuations. Therefore, the probability for n dopants, which are covalently bonded to each other, to be simultaneously in a desorbed state is given by the relationship: P(n)=A(1−t)ⁿ. For t=0.7 and n=20 the ratio of P(20) to P(1) is ˜1×10⁻¹⁰; which is so small that the doping can be effectively permanent. The higher the A factors and strength of the donor-acceptor complex, the smaller the number of dopant moieties required per unit length of coupled dopant chain to achieve the desired stability. The multiplicity of combined dopant moieties is from 3 to about 50 moieties and generally the combined dopant moieties per chain are about 5 to about 20 or more.

The amount of charge transferred between a nanotube and a dopant moiety, and therefore also the strength of the interaction between the two, depends on the energy difference between the work function of the nanotube and the lowest unoccupied molecular orbital (LUMO) energy for acceptor doping or the highest occupied molecular orbital (HOMO) energy for donor doping. Importantly, because the work function of the nanotube is shifted by the total amount of charge transferred, the strength of the interaction between the nanotube and the dopant moiety is doping concentration dependent, where the strength of the individual interactions decrease with an increase of the degree of doping. This degree of doping dependence of individual doping moieties is the reason that with uncoupled dopant moieties dedoping is initially rapid at high doping concentrations. Therefore, the number of coupled dopant moieties per unit of coupled chain length depends on the doping concentration. The novel DCPs are designed to ensure that a desired degree of doping and doping stability is achieved. The stability of the doping provided by the novel DCPs is particularly advantageous during solution processing steps of device fabrication where, otherwise, dissolution of weakly bound species could occur, and is advantageous at elevated operating temperatures where conformational rearrangement of weakly bound coupled chains can occur.

The novel DCPs have charge transfer dopant moieties that are repeated a sufficient number of times in a relatively large, covalently coupled molecule to assure stable charge transfer doping of the dopant moieties within a DCP. In various embodiments of the invention, DCPs can contain charge transfer moiety in the polymer backbone, as side groups covalently attached to a polymer backbone, or a combination of moieties within the backbone and attached to side groups. In general, the dopant moieties will be coupled to the polymer backbone by a linking moiety where the linking moiety and dopant moiety are not part of the polymer backbone. In this manner the linking moiety at least partially decouples the conformational freedom of the dopant moiety from the polymer backbone such that it can be more readily present to the nanotubes surface with a proper orientation for charge transfer doping.

Control of the degree of charge transfer reactions and therefore the doping level is a necessary condition for rational application of doped nanotubes in electronic and electro-optic devices. The design of the novel DCPs provides control over the degree of doping by the number of doping moieties incorporated per unit length of the polymer and results in high stability of the doping. The specific degree of nanotube doping by the DCPs (i.e. the charge transferred to or from a nanotube per unit length of nanotube) depends on factors including the specific charge transfer moieties used, the density of the charge transfer moieties per unit length of the polymer backbone, conformational freedom of the polymer backbone, and conformational freedom of the dopant moiety such that it may be presented to the nanotubes with an effective orientation relative to the nanotubes surface that promotes charge transfer between the dopant moiety and nanotubes. The possible degree of nanotube doping for a DCP can be determined by detailed modeling of complexation to a DCP structure or experimentally, such that the degree of doping is sufficient and is achieved by the density of the charge transfer moieties built in per unit length of polymer backbone. The degree of doping for each density can be determined spectroscopically, by monitoring the integrated intensity of the nanotube absorption bands, or by electronic transport measurements, where the resistivity of a film of the doped nanotubes is monitored. Three distinct densities of the charge transfer moieties typically suffice to yield the monotonic function that describes the degree of doping as a function of the density of the charge transfer moieties per length of polymer backbone. Once such calibration has been determined for a DCP nanotubes complex, the specifically desired ultimate doping level can be achieved using a DCP with a specific density of the charge transfer moiety in the polymer.

The novel DCPs have a controlled quantity of dopant moieties capable of charge-transfer complexation as donors or acceptors with carbon nanotubes such that the electronic properties can be modified in a stable predetermined manner. These moieties have sufficient conformational freedom and mobility to permit optimal interaction of each moiety with a nanotube yet be covalently coupled together in a manner that inhibits the free diffusion of the polymer and its dopant moieties from the surface of the nanotubes, which overcomes the significant limitations observed using individual uncoupled dopant moieties to dope nanotubes due to their propensity for dedoping, or the inhibition of doping that can occur for dopants locked into a relatively rigid polymer backbone. This conformational freedom enables the formation of the strongest most stable complexation, such that the complex can be maintained in an environment that would otherwise permit desorption and loss of uncoupled moieties.

In an embodiment of the invention, many dopants are coupled to each other in a single polymer, where the local mobility of the doping moiety is not inhibited, to assure the stability of the charge transfer doping with the nanotubes. In this way, when charge back-transfer occurs to one doping moiety, its diffusion from the nanotube surface is constrained to a small volume because of the interaction of the other doping moieties attached to the same polymer chain. Such a multiplicity of charge transfer interactions coupled to each other by covalent bonds maintains a high effective molarity of dopants to maximize control over the extent of doping. Although long range diffusion of the dopant moiety from the nanotubes is inhibited since it is coupled to the DCP, short range diffusion can occur, which allows the dopants and polymer to reorganize to optimize doping and the stability of the doping.

In one embodiment the invention, donor or acceptor dopant moieties connected to a polymer backbone via flexible linkers. This approach is well developed for non-charge transfer moieties with conducting polymer backbones as disclosed in Reynolds et al., PCT/US2007/081121 filed Oct. 11, 2007, incorporated herein by reference. For p-type dopants, tetracyanoquinodimethane (TCNQ) derived moieties, can be used to achieve individual charge transfer interaction where the TCNQ unit extracts electrons from the nanotube. Other known p-type dopant can be modified to be linked to a polymer chain. These p-type dopants include derivatized TCNQs (e.g. halogenated-TCNQs), 1,1-dicyanovinylenes, 1,1,2-tricyanovinylenes, benzoquinones, pentafluorophenol, dicyanofluorenone, cyano-fluoroalkylsulfonyl-fluorenones, pyridines, pyrazines, triazines, tetrazines, pyridopyrazines, benzothiadiazoles, heterocyclic thiadiazoles, porphyrins, phthalocyanines, and electron accepting organometallic complexes. An n-type dopant moiety that can be used is derived from tetrathiafulvalene (TTF) or its closely related analogue bis-ethylenedithiolo-TTF (BEDT-TTF), where these n-type moieties donate electrons to the nanotube. Other known n-type dopants that can be modified to be used as donor moieties in the compositions and methods of this invention include amines and polyamines, other functionalized TTF derivatives, tetraselenafulvalenes (often used in organic superconductors), fused heterocycles, heterocyclic oligomers, and electron donating organometallic complexes.

In an embodiment of the invention, where the charge transfer dopant moieties are linked to a polymer backbone via a side-chain to the polymer backbone, this side chain is generally chosen to provide the flexibility needed to decouple the short range motion of the dopant moiety from the backbone of the polymer. The side chain is generally a non-conjugated chain where less than about 50 atoms, for example, 20, 18, 16, 14, 12, 8, 6, 5, 4, or 3, are linearly linked together between the polymer backbone and the dopant moiety. The side chains can be: normal, branched or cyclic hydrocarbons that can include one or more heteroatoms such as O, S, or N; linear, branched, or cyclic siloxanes; or, particularly when the backbone is a conducting polymer, a conjugated linear or cyclic hydrocarbon that can include one or more heteroatoms such as O, S, or N. Several dopant moieties can be situated regularly or irregularly on a side chain such that several dopant moieties are connected to the linear side chain by linking groups. Alternatively, the side chain can be branched, with dopant moieties terminating each branch. Multiple side chains can be attached to any given repeating unit of the polymer backbone.

Structure 1 shows a specific embodiment of a DCP incorporating methylmethacrylate repeat units and DCP functionalized methacrylate repeat units. The feed ratio, of spacer unit to DCP containing unit is defined as y/x, where y=n−x, which determines the average number of dopant moieties per unit of polymer backbone length. The DCP functionalized repeat unit contains a pentamethylene linkage, which allows the dopant moiety extra degrees of conformational freedom to decouple its motion from that of the polymer backbone. The dopant moiety is a 2-(4-(cyanomethylidenyl)-2,3,5,6-tetrafluorocyclohexa-2,5-dienylidene)malononitrile.

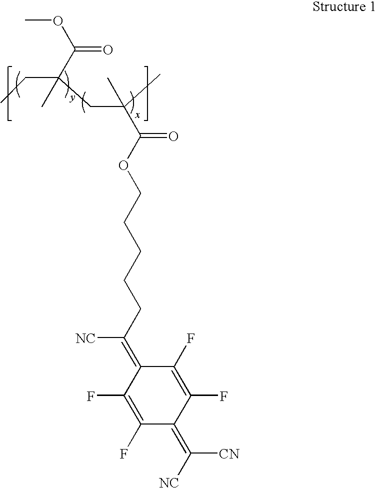

In another embodiment of the invention, the dopant moiety can be incorporated directly into the polymer's backbone provided that the backbone is designed with sufficient conformational flexibility to permit nearest neighbor dopant moieties to couple to the nanotube via charge transfer reactions. This coupling results in stable charge transfer doping of the nanotubes. Fine control of the doping density is achieved by tailoring the number of dopants coupled to a given polymer backbone per unit length of the backbone in conjunction with the strength of the electron donating or accepting (ionization potential or electron affinity) of the moiety used.

In embodiments of the invention where maximal doping is needed the polymer can have a dopant moiety attached to every repeating unit of the polymer. In an alternative embodiment the dopant moieties are attached to only a fraction of the repeating units of the polymer. This copolymer embodiment allows for the tailoring of the dopant containing polymer to the application for which the polymer/nanotube assembly is prepared, allowing optimization of the assembly properties, minimization of costs, and/or permission of the use of a desired process methodology. Based upon the preferred conformations of the polymer backbone and the spacing of the dopant moieties with respect to the surface features of the nanotubes used, such a copolymer can be statistical or periodic such that a desired presentation of the dopant moiety to the nanotubes is achieved. The molecular weight need only be sufficient to permit the desired number of combined dopant moieties to be contained in a given polymer chain. The polymer or copolymer can display a narrow, normal or highly dispersed molecular weight distribution. When that number of combined dopant moieties per polymer is small, about 5 to about 10, it can be advantageous to have a molecular weight distribution that is narrow and if a copolymer is used, that the copolymer be periodic as opposed to random to assure that a large proportion of the polymer contains more than two dopant moieties per chain.

The polymer used to couple the dopant moieties via linking moieties can vary considerably based on the use intended for the nanotube-polymer assembly. The polymer's backbone can be conjugated, partially conjugated or non-conjugated. The polymer can be a copolymer with conjugated segments and non-conjugated segments. The polymer can have a glass transition temperature below ambient temperatures and behave as a viscous liquid, and if desired in an embodiment of the invention, subsequently cross-linked to a rubber after complexing to nanotubes. The polymer may exhibit a glass transition temperature above ambient temperatures where it can be processed as a melt or in solution. The dopant moieties can be locked to the nanotubes in an essentially non-exchanging state upon cooling, or removal of the solvent. It may be preferred for specific applications that the chemical and physical state of the polymer is one where fabrication of an electronic device can be carried out such that all necessary electrical contacts are readily formed. Hence, in some embodiments, cross-linking or fusion of polymer can be carried out on demand to permit any desired contact of the nanotube surface with another electrically conductive material. In other embodiments, the dopant coupled polymer can be of a design that enhances the coupling of the nanotubes to electrodes or semiconducting components of a device. These embodiments permit the designed modification of the nanotubes by a stable dopant while subsequently leaving the assembly in a state to be easily incorporated into a device.

The polymer can be any polymer or copolymer prepared by any step growth or chain growth polymerization technique. Step growth polymers require a di- or polyfunctional monomer that contains a linked dopant moiety. Inclusive in the step growth polymers that can be used in the practice of the invention are polyesters, polyamides, polyurethanes, polyureas, polycarbonates, polyaryletherketones, and polyarylsulfones. Inclusive with the chain growth polymers are polyolefins, polyacrylates, polymethacrylates, polystyrenes, polyacrylamides, polyalkadienes, and polyvinylethers. Non-organic backbones such as polysiloxanes can be used in the practice of the invention. Natural polymers such as polypeptides and polysaccharides can be modified or polymerized artificially to include dopant moieties. Among conjugated polymers that can be used for the practice of the invention are: polyfluorene, poly(p-phenylene), PPV, polythiophene, polydioxythiophene, polypyrrole, polydioxypyrrole, polyfuran, polydioxyfuran, polyacetylene, and polycarbazole. The architecture of the polymers can be linear, branched, hyperbranched, star-shaped and dendritic. The placement of the dopant moiety can be random or regular in a copolymer. For example, a linear polymer can be formed radically by vinyl addition polymerization where the reactivity ratios of the dopant containing moiety and the vinyl comonomer promote isolation, alternation, or specific average sequence lengths of the dopant containing units. A living copolymerization can be carried out to have a specific length sequence of the dopant containing units situated at an end, or in one or more specific blocks within the copolymer. The dopant containing units can be exclusively at the periphery of a dendrimer. The dopant units can be constrained to one, a few, or all branches of a branched, hyperbranched or star shaped copolymer.

The invention allows control of the doping density per length of nanotube. One embodiment of the invention is to control the amount of DCP to which the nanotubes are exposed, limits the stoichiometry between the charge transfer moieties and the number of carbon atoms in the nanotubes, permitting the achievement of a desired doping density and resulting electronic properties from the complex. In this embodiment, the amount of a specific DCP is below a saturation level that can be achieved for the specific DCP. Such non-saturation doping requires that the desired stoichiometry is predetermined and achieved in a manner where deposition results with effective uniformity of the complex.

In another embodiment of the invention, control of the doping density is achieved by the structure of the DCP. In this embodiment the density of the doping moiety per unit length of the DCP determines the saturation doping level between the nanotubes with the specific DCP where sufficient polymer is added to the nanotubes but the saturation level is less than that achievable with a DCP with a higher density of doping moieties per unit length of the polymer. For example, where the DCP is a copolymer, the fraction of the dopant can be controlled such that the volume of non-dopant repeating units on an individual polymer chain can inhibit the attachment of dopant moieties from the same or other DCP even though the nanotube would accept additional dopant molecules absent the volume of non-dopant repeating units where additional dopant moieties could diffuse to the surface.

Another embodiment for control of the amount of stable DCP nanotubes complex between the nanotube and DCP involves competitively complexing the polymer with a monomeric dopant, such that a desired fraction of the doping is between the nanotube and dopants on the DCP, but that all possible sites on the nanotube are doped. Subsequently, desorption of the monomeric dopants can be promoted to leave nanotubes solely complexed with the DCP in a non-saturated state. The DCP can be included with the monomeric dopants in a combination where all of the DCP is bound by doping to the nanotubes and all of the monomeric dopant is bound to the nanotubes before dedoping and removal of the monomeric dopant. The DCP can be included with the monomeric dopants in a combination where all of the DCP is bound but an excess of monomeric dopant is used and the excess of monomeric dopant is removed with the dedoped monomeric dopant. The DCP can be included with the monomeric dopants in a combination where an excess of both the DCP and monomeric dopant is used and the excess of the DCP and monomeric dopant are removed before dedoping and removal of the nanotubes bound monomeric dopant.

These polymer coupled dopant moieties can be associated with individual nanotubes or nanotube bundles by dispersing them in solution followed by filtration and washing to remove any excess polymer that may be present. Alternatively, in the case of prefabricated nanotube networks or films, solvent bearing the dopant containing polymer can be flooded across the film or network and the solvent evaporated after a sufficient incubation time. Alternatively, in the case of prefabricated nanotube networks or films the, solvent bearing the dopant containing polymer can be flooded across the film or network, whereupon a spontaneous association of the dopant polymer to the nanotube network occurs which stabilizes after a sufficient incubation time. The films bearing the dopant can be removed from solution, soaked in blank solvent to remove residual non-adsorbed polymer, and the films dried. As indicated above, these dopant containing polymers can serve the multifunctional role of doping the nanotubes and coupling the nanotubes to electroactive materials. The nature of the dopant containing polymer can be varied to provide a surface that is compatible with improving the adhesion of the nanotubes as films to electrode materials (vapor deposited metals, conducting pastes, conducting polymers) or to other polymers or film (e.g. light emitting polymers, photovoltaic polymers, electrochromic polymers) deposited by spin-coating, spray coating, printing, or other processing method.

Charge transfer dopant monomers that combine the moiety linked to one or more polymerizable groups can be deposited on nanotubes creating a molecular coating followed by a polymerization of the groups. The in-situ polymerizations can be induced chemically, thermally, photolytically, or any combination thereof. An embodiment employing a photolithographic technique can be used to form regions on SWNT network films that have p-type dopants while adjacent regions contain n-type dopants. If these regions are in contact, p-n junctions are formed providing electrically rectifying junctions between the regions. Such p-n junctions can also be formed by suitable photolithographic masking of a distinct SWNT film region, exposing the unmasked portion to either a p-type or n-type DCP, and after removal of the mask, exposing the newly unmasked SWNT film to the complimentary n-type or p-type DCP.

Due to the non-covalent nature of the Sticky Dopant/nanotube interaction, detachment of the polymer can be promoted by the application of an appropriate voltaic, chemical, or photochemical stimulus suitable to shift the chemical equilibrium of the system towards the uncomplexed state, permitting dopant release on demand. In this manner, the dopant containing polymers can be employed as chemical or drug release agents where release occurs by the induced detachment from the nanotubes. Such drugs or chemicals could either be encapsulated by the dopant containing polymer or comprise a part of the polymer.

Among electronic devices that can be fabricated partially or whole from a nanotube dopant containing polymer composite are: solar cell and photovoltaic devices; light emitting diodes; capacitors, batteries and supercapacitors; fuel cells, transistors, lasers, chemical and biological sensors; and optical limiters, modulators, transducers, and non-linear optical devices. One skilled in the art can further identify other devices that can employ the composites of the invention.

We claim:

1.-21. (canceled)

22. A dopant coupled polymer (DCP), comprising:
a polymer;
a multiplicity of dopant moieties capable of donating or accepting electrons from a carbon nanotube surface; and
a multiplicity of linking moieties connects said dopant moieties to the polymer, wherein said linking moieties and said dopant moieties are not part of said polymer's backbone.

23. The DCP of claim 22, wherein said polymer comprises a homopolymer or copolymer with an architecture that is linear, branched, hyperbranched, dendritic, star shaped, or as a network.

24. The DCP of claim 22, wherein said polymer has a non-conjugated backbone.

25. The DCP of claim 2, wherein said polymer has a partially or fully conjugated backbone.

26. The DCP of claim 22, wherein said dopant moieties independently comprise electron accepting charge transfer units.

27. The DCP of claim 26, wherein said dopant moieties independently comprise derivatives of TCNQs, halogenated-TCNQs, 1,1-dicyanovinylenes, 1,1,2-tricyanovinylenes, benzoquinones, pentafluorophenol, dicyanofluorenone, cyano-fluoroalkylsulfonyl-fluorenones, pyridines, pyrazines, triazines, tetrazines, pyridopyrazines, benzothiadiazoles, heterocyclic thiadiazoles, porphyrins, phthalocyanines, or electron accepting organometallic complexes.

28. The DCP of claim 22, wherein said dopant moieties comprise electron donating charge transfer units.

29. The DCP of claim 28, wherein said dopant moieties independently comprise derivatives of tetrathiafulvalene (TTF), bis-ethylenedithiolo-TTF (BEDT-TTF), amines, polyamines, tetraselenafulvalenes, fused heterocycles, heterocyclic oligomers, and electron donating organometallic complexes.

30. The DCP of claim 22, wherein said multiplicity of dopant moieties comprises at least five of the dopant moieties.

31. The DCP of claim 22, wherein said linking moiety comprises a non-conjugated chain where one to about 50 atoms are linearly linked together between said polymer and said dopant moiety.

32. The DCP of claim 22, wherein said linking moiety comprises a non-conjugated chain where four to about 20 atoms, are linearly linked together between said polymer and said dopant moiety.

33. The DCP of claim 22, wherein said linking moiety comprises a normal, branched or cyclic hydrocarbon with or without heteroatoms selected from the group consisting of O, S, or N or a linear, branched, or cyclic siloxane.

34. The DCP of claim 22, wherein said linking moiety comprises a conjugated chain where one to about 50 atoms, are linearly linked together between said polymer and said dopant moiety.

35. The DCP of claim 22, further comprising a plurality of carbon nanotubes, wherein a plurality of said dopant moieties forms a charge transfer complex to a surface of the carbon nanotubes.

36. A method to dope carbon nanotubes comprising the steps of:
providing a DCP comprised of at least one polymer with a multiplicity of dopant moieties linked via linking moieties to the polymer, wherein the linking moiety and said dopant moiety are not part of the polymer backbone;
providing at least one carbon nanotube; and
mixing said polymers with said nanotubes.

37. The method of claim 36, wherein said step of providing said DCP comprises providing said DCP as a liquid or in solution.

38. The method of claim 36, wherein said step of providing said DCP comprises providing at least one monomer and a means to polymerize said monomer into said DCP.

39. The method of claim 36, further comprising the step of cross-linking the DCP in the presence of the nanotubes.

40. The method of claim 36, further comprising the steps of:
providing a monomeric dopant capable of doping said nanotubes; and
removing said monomeric dopant, wherein a doping level of the doped nanotubes is less than saturated.

41. A doped nanotube composition comprising:
at least one carbon nanotube; and
at least one DCP comprising a polymer containing a multiplicity of dopant moieties linked to said polymer via a linking moiety, wherein said linking moiety and said dopant moiety are not part of the polymer backbone, capable of donating or accepting electrons from said carbon nanotube's surface, wherein the ratio of the mass of said nanotubes to the mass of said DCP provides a specific conductivity to said composition.
